(19) United States
(12) Patent Application Publication
(10) Pub. No.: US 2026/0359852 A1
(43) Pub. Date: Nov. 12, 2026

(54) REWARD ALIGNMENTS FOR RECOMMENDATION SYSTEMS

(71) Applicant: NETFLIX, INC., Los Gatos, CA (US)

(72) Inventors: Swanand Arvind JOSHI, Sunnyvale, CA (US); Jaewook YU, Sammamish, WA (US); Gary TANG, Saratoga, CA (US); Varad Subhash PATHAK, Menlo Park, CA (US); Anuj Ramesh SHAH, Saratoga, CA (US); Kriti Kohli NELSON, New York, NY (US)

(21) Appl. No.: 19/666,613

(22) Filed: May 4, 2026

Related U.S. Application Data
(60) Provisional application No. 63/802,934, filed on May 9, 2025.

(51) Int. Cl. G06Q 30/0214; G06N 20/00

(52) U.S. Cl. CPC G06Q 30/0214; G06N 20/00

(57) ABSTRACT

One embodiment sets forth a method for training reward-aligned recommendation models. According to some embodiments, the method can be implemented by a computing device, and includes the steps of performing a first stage of training on a recommendation model using engagement data that includes item representations and associated context data to generate a pre-trained recommendation model, and performing a second stage of training on the pre-trained recommendation model using proxy reward values that represent long-term user satisfaction to generate a reward-aligned recommendation.

### CROSS-REFERENCE TO RELATED APPLICATIONS

### Field of the Various Embodiments

This application claims priority benefit of the United States Provisional Patent Application titled, “TECHNIQUES FOR IMPLEMENTING REWARD ALIGNMENTS FOR RECOMMENDATION SYSTEMS,” filed on May 9, 2025, and having Ser. No. 63/802,934. The subject matter of this related application is hereby incorporated by reference.

### BACKGROUND

### Field of the Various Embodiments

Embodiments of the present disclosure relate generally to computer science and computer networks for streaming media, and more specifically, to reward alignments for recommendation systems.

### Description of the Related Art

For computing systems, a recommendation system may be a computing system or service that filters items, such as products, services, content, and the like, to provide items likely to be relevant to a particular user. Recommendation systems may analyze large datasets reflecting user behaviors, preferences, past interactions, and similar information, and may use that analyzed information to generate predictions of user interests. As a result, recommendation systems may be useful for narrowing a large number of choices and helping to avoid information overload.

Despite these advantages, significant technical challenges arise because recommendation systems often focus on immediate metrics, such as clicks or other short-term metrics, rather than on optimizing long-term user satisfaction. For example, a recommendation system may provide a list of items to a user, and the user may find the recommended items to be relevant. Traditionally, however, success of the recommendation system may be measured using short-term engagement metrics, such as click-through rate and/or take rate of recommended items. Under such an approach, the recommendation system may be deemed successful when the user selects an item from the list, even though such selection may not contribute positively to the long-term satisfaction of the user. As a result, training and optimization based primarily on such short-term engagement signals may cause the recommendation system to allocate computational resources toward patterns that are weakly correlated, or even misaligned, with longer-term user outcomes.

By way of example, in a media recommendation system, given a list of media items, a user may select an item due to an unwillingness to continue reviewing the list, decision fatigue, lack of time, and/or similar factors, even though the selected media item may not be the media item with which the user actually desires to engage. Consequently, the selected media item may fail to contribute positively to long-term user satisfaction and may even contribute negatively to the long-term satisfaction of the user with the service that provides the recommendation system. In such circumstances, the user selection may constitute a low-quality training or feedback signal, such that storage, memory, and processing resources may be expended to collect, maintain, and learn from data that does not accurately reflect the underlying preferences of the user. This difficulty is compounded because long-term satisfaction may be evaluated using metrics that manifest only over longer periods of time, such as whether the user renews the service in a next month, a next year, or another future period, a number of days within a time period (e.g., week, month, year, etc.) during which the user accesses the service, a number of minutes that the user uses the service over a time period, and so on.

In some approaches, long-term satisfaction may be measured and optimized separately from recommendation generation, and resulting signals may be provided for use in recommendation processing. However, such arrangements may be relatively inefficient, because they may introduce additional overhead associated with maintaining distinct processing stages, data flows, and signal exchange paths. For example, such approaches may separately store overlapping datasets, maintain separate feature representations, execute separate model inference or training pipelines, and exchange signals over one or more networks or inter-process interfaces, thereby increasing memory usage, storage usage, bandwidth consumption, latency, and overall computational overhead. Accordingly, a technical challenge can arise from attempting to account for both short-term user engagement and long-term user satisfaction without incurring undue system overhead.

Another technical challenge arises from measuring long-term user satisfaction metrics in the first place. More specifically, although short-term engagement may be measured using relatively straightforward metrics, such as click-through rate and/or take rate of recommended items, long-term satisfaction may be difficult to measure directly and/or to attribute. For example, a long-term satisfaction metric, such as whether a user renews a subscription to the service, can be difficult to correlate with, or attribute to, any particular recommended item. In addition, any number of other factors may contribute to non-renewal of the subscription, where some factors may be controllable by the service and other factors may not be controllable by the service. As a result, long-term satisfaction data may be sparse, delayed, noisy, and/or only indirectly attributable to particular recommendation events, which can reduce label quality and complicate model training, evaluation, and updating. Because measurements of long-term user satisfaction are difficult to directly measure and/or attribute, those measurements (e.g., measured metrics, metric weighting, etc.) may need to be refined over time.

A further technical challenge arises because recommendation processing may become tied to a particular measurement of long-term satisfaction used during training, calibration, or optimization. If the measurement of long-term satisfaction is later refined, components that depend on the earlier measurement may require retraining, recalibration, reweighting, or other updating using the refined long-term satisfaction measurement, thereby increasing computational overhead. For large-scale recommendation systems, such updating may consume substantial processor cycles, memory, storage input/output, and network bandwidth, and may also increase deployment complexity and delay propagation of updated recommendation behavior into production environments.

Accordingly, what is needed in the art are more effective techniques for implementing recommendation systems that can account for both short-term engagement and long-term user satisfaction.

### SUMMARY

One embodiment sets forth a computer-implemented method for training reward-aligned recommendation models. According to some embodiments, the method includes performing a first stage of training on a recommendation model using engagement data that includes item representations and associated context data to generate a pre-trained recommendation model; and performing a second stage of training on the pre-trained recommendation model using proxy reward values that represent long-term user satisfaction to generate a reward-aligned recommendation model.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques relative to prior approaches is that the disclosed techniques implement a multi-stage training methodology for a reward-aligned recommendation model that reduces the technical burden associated with incorporating long-term user satisfaction into recommendation processing. More specifically, a first stage of training can generate a pre-trained recommendation model using engagement data associated with short-term user engagement, while a second stage of training can adapt the pre-trained recommendation model using proxy reward values that represent long-term user satisfaction. Because the pre-trained recommendation model can be reused across different proxy reward functions and/or refined proxy reward functions, retraining of the pre-trained recommendation model (e.g., to perform item recommendation) may be avoided when the proxy reward function is changed. Thus, the disclosed techniques can avoid repeated end-to-end retraining of the recommendation model each time a long-term satisfaction measurement, weighting, or formulation is adjusted.

As a result, the disclosed techniques can reduce model training cost, processor utilization, memory usage, storage input/output, network bandwidth consumption, and overall computational overhead relative to approaches that retrain an entire recommendation model after refinement of a long-term reward formulation. In addition, the disclosed techniques can improve scalability by allowing multiple candidate proxy reward functions to be evaluated, compared, and refined using the pre-trained recommendation model, thereby enabling more efficient exploration of different long-term satisfaction formulations. The disclosed techniques can also improve technical performance by preserving information learned from short-term engagement data while separately aligning the model with longer-term reward signals that may be sparse, delayed, indirect, and/or noisy. Accordingly, the disclosed techniques can improve training efficiency, reduce system-resource consumption, and facilitate iterative refinement of long-term reward alignment in recommendation systems.

These technical advantages provide one or more technological advancements over prior art approaches.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a network infrastructure used to distribute content to content servers and endpoint devices, according to various embodiments of the invention;

FIG. 2 is a block diagram of a content server that may be implemented in conjunction with the network infrastructure of FIG. 1, according to various embodiments of the present invention;

FIG. 3 is a block diagram of a control server that may be implemented in conjunction with the network infrastructure of FIG. 1, according to various embodiments of the present invention; and

FIG. 4 is a block diagram of an endpoint device that may be implemented in conjunction with the network infrastructure of FIG. 1, according to various embodiments of the present invention.

FIG. 5 is a block diagram of a computer-based system according to various embodiments.

FIG. 6 illustrates a first stage training of multi-staged training for the reward-aligned recommendation model, in accordance with aspects of the present disclosure.

FIG. 7 illustrates a second stage training of multi-staged training for the reward-aligned recommendation model, in accordance with aspects of the present disclosure.

FIG. 8 illustrates training for the reward-aligned recommendation model using refined proxy reward functions, in accordance with aspects of the present disclosure.

FIG. 9 provides further details for pre-trained recommendation model reuse, in accordance with aspects of the present disclosure.

FIG. 10 is a flow diagram illustrating a technique 1000 for implementing reward alignments for recommendation systems, in accordance with aspects of the present disclosure.

### DETAILED DESCRIPTION

In the following description, numerous specific details are set forth to provide a more thorough understanding of the embodiments of the present invention. However, it will be apparent to one of skill in the art that the embodiments of the present invention may be practiced without one or more of these specific details.

As described herein, recommendation systems can assist users in navigating large numbers of products, services, or content items by predicting relevance from user behavior, preferences, and prior interactions. However, conventional recommendation systems often optimize for short term engagement signals, such as clicks, rather than long term user satisfaction. Such optimization creates a technical problem because an immediate user selection may reflect decision fatigue, time constraints, or reluctance to continue browsing, rather than actual user preference. Consequently, feedback derived from the immediate user selection may constitute a low quality training signal and may cause the recommendation system to allocate storage, memory, and processing resources to patterns that are weakly correlated with favorable long term outcomes. The technical challenges are further compounded because long term satisfaction can be difficult to measure directly and difficult to attribute to a particular recommendation event. Instead, long term satisfaction may be inferred from delayed, sparse, noisy, and indirect indicators, such as subscription renewal, repeated service usage, or aggregate usage over future periods, and such indicators may also be influenced by controllable and uncontrollable factors unrelated to any specific recommendation. Existing approaches that evaluate long term satisfaction separately from recommendation generation may introduce additional inefficiencies by requiring distinct processing stages, overlapping data storage, separate feature representations, separate model pipelines, and additional signal exchanges across networks or inter process interfaces, thereby increasing latency, bandwidth consumption, and overall computational overhead. Moreover, when a measurement of long term satisfaction is refined, dependent recommendation components may require retraining, recalibration, or reweighting. In large scale systems, such updating may consume substantial processor cycles, memory, storage input and output, and network resources, while delaying deployment of updated recommendation behavior.

To address the foregoing issues, the disclosed techniques set forth a recommendation system that can be trained to generate recommendations that can yield short-term user engagements as well as increase long-term user satisfaction. To provide optimization for multiple learning objectives, the recommendation system may be trained using a multi-stage training methodology. In some cases, stages of the multi-stage training methodology may be organized based on the learning objectives. For example, a first stage of training may be performed based on a short-term user engagement objective using engagement data to generate a pre-trained recommendation model. The pre-trained recommendation model may be reused Such engagement data may include item representations along with context. An item representation may be a representation of an item (e.g., a recommended item), and the context may encode historical preferences for the item. In some cases, the engagement data may be structured as a plurality of triplets, where a triplet of the plurality includes a representation of an item (e.g., a recommended item), context information encoding historical preferences of the user, and a reward. Values of the reward may be related to the long-term satisfaction objective and the first stage of training may bypass (e.g., exclude) the use of any particular reward function and/or the reward value. Rather, the reward function and reward value may be used in a second stage of training based on the long-term user satisfaction objective.

The second stage of training may be performed on the pre-trained recommendation model to generate a reward-aligned recommendation model using a proxy reward function. The proxy reward function may represent long-term user preferences. The proxy reward function may map reward values of a triplet to the corresponding item representation and context. In some cases, the proxy reward function may be based on one or more metrics, such as whether a user watches a media item to completion, where one or more metrics may be combined to provide an indication of long-term user satisfaction. The proxy reward function may be refined over time to better align with long-term user satisfaction. In some cases, the second stage of training may be performed using a refined proxy reward function. The pre-trained recommendation model from the first stage of training may be reused to train the refined proxy reward function without retraining the pre-trained recommendation model.

One technical advantage of the disclosed techniques relative to prior approaches is that the disclosed techniques implement a multi-stage training methodology for a reward-aligned recommendation model that reduces the technical burden associated with incorporating long-term user satisfaction into recommendation processing. More specifically, a first stage of training can generate a pre-trained recommendation model using engagement data associated with short-term user engagement, while a second stage of training can adapt the pre-trained recommendation model using proxy reward values that represent long-term user satisfaction. Because the pre-trained recommendation model can be reused across different proxy reward functions and/or refined proxy reward functions, retraining of the pre-trained recommendation model (e.g., to perform item recommendation) may be avoided when the proxy reward function is changed. Thus, the disclosed techniques can avoid repeated end-to-end retraining of the recommendation model each time a long-term satisfaction measurement, weighting, or formulation is adjusted.

As a result, the disclosed techniques can reduce model training cost, processor utilization, memory usage, storage input/output, network bandwidth consumption, and overall computational overhead relative to approaches that retrain an entire recommendation model after refinement of a long-term reward formulation. In addition, the disclosed techniques can improve scalability by allowing multiple candidate proxy reward functions to be evaluated, compared, and refined using the pre-trained recommendation model, thereby enabling more efficient exploration of different long-term satisfaction formulations. The disclosed techniques can also improve technical performance by preserving information learned from short-term engagement data while separately aligning the model with longer-term reward signals that may be sparse, delayed, indirect, and/or noisy. Accordingly, the disclosed techniques can improve training efficiency, reduce system-resource consumption, and facilitate iterative refinement of long-term reward alignment in recommendation systems.

These technical advantages provide one or more technological advancements over prior art approaches.

### System Overview

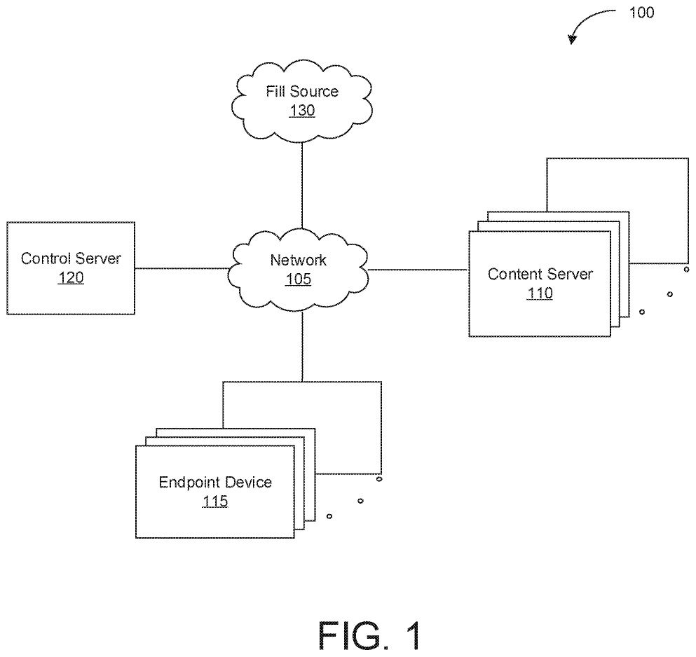

FIG. 1 illustrates a network infrastructure 100 used to distribute content to content servers 110 and endpoint devices 115, according to various embodiments of the invention. As shown, the network infrastructure 100 includes content servers 110, a control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computers, smartphones, tablets, consoles and handheld video game systems, digital video recorders (DVRs), DVD players, connected digital TVs, dedicated media streaming devices (e.g., the Roku® set-top box), and/or any other technically feasible computing platform that has network connectivity and is capable of presenting content, such as text, images, video, and/or audio content, to a user.

Each content server 110 may include a web server, a database, and a server application 217 configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content servers 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well understood, any cloud-based services may be included in the architecture of FIG. 1 beyond the fill source 130 to the extent desired or necessary.

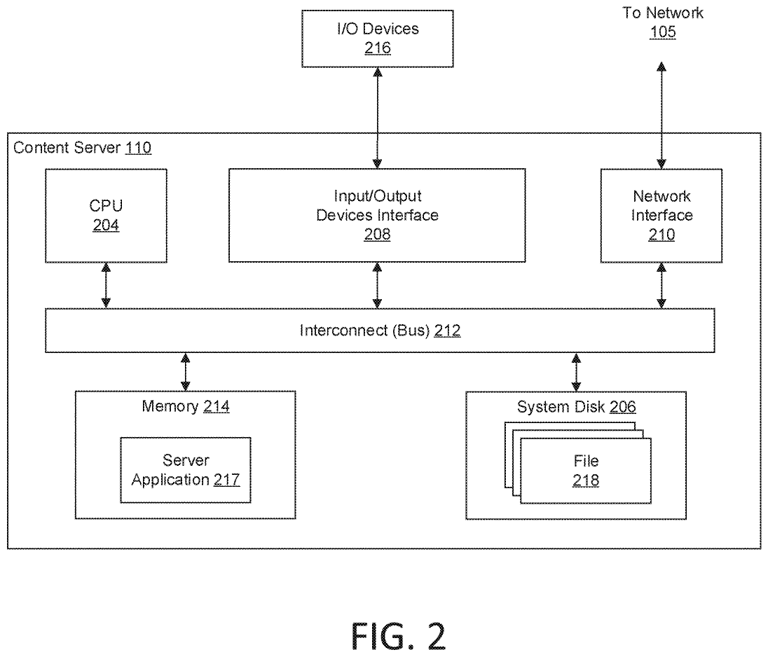

FIG. 2 is a block diagram of a content server 110 that may be implemented in conjunction with the network infrastructure 100 of FIG. 1, according to various embodiments of the present invention. As shown, the content server 110 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, the I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The system disk 206 may include one or more hard disk drives, solid state storage devices, or similar storage devices. The system disk 206 is configured to store non-volatile data, such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the system disk 206 and transmits the file 218 to an endpoint device 115 or a content server 110 via the network 105.

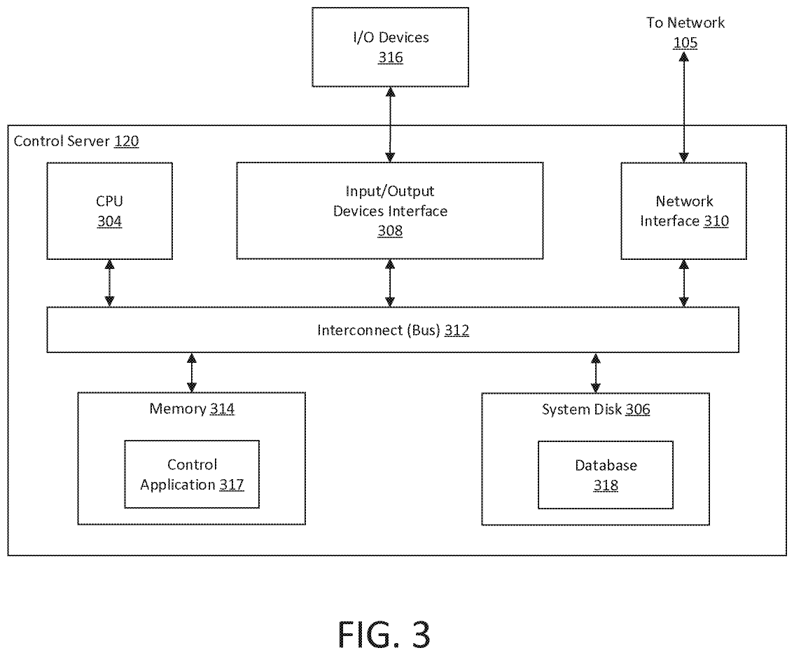

FIG. 3 is a block diagram of a control server 120 that may be implemented in conjunction with the network infrastructure 100 of FIG. 1, according to various embodiments of the present invention. As shown, the control server 120 includes, without limitation, a central processing unit (CPU) 304, a system disk 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the system disk 306. The interconnect 312 is configured to facilitate transmission of data between the CPU 304, the system disk 306, the I/O devices interface 308, the network interface 310, and the system memory 314. The I/O devices interface 308 is configured to transmit input data and output data between the I/O devices 316 and the CPU 304 via the interconnect 312. The system disk 306 may include one or more hard disk drives, solid state storage devices, and similar storage devices. The system disk 306 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

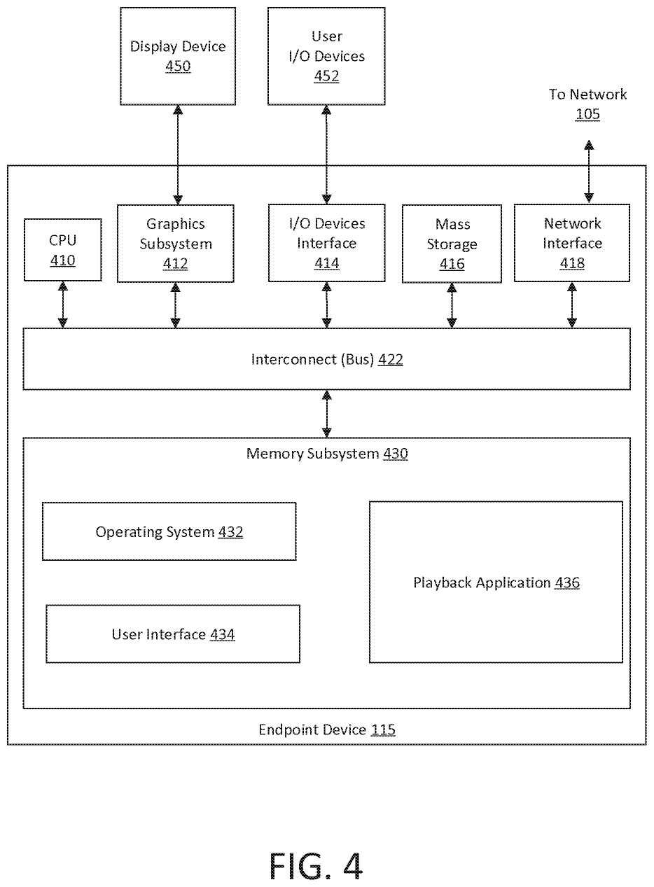

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage unit 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O device interface 414, mass storage unit 416, network interface 418, and memory subsystem 430.

In some embodiments, the graphics subsystem 412 is configured to generate frames of video data and transmit the frames of video data to a display device 450. In some embodiments, the graphics subsystem 412 may be integrated into an integrated circuit along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. The I/O device interface 414 is configured to receive input data from user I/O devices 452 and transmit the input data to the CPU 410 via the interconnect 422. For example, user I/O devices 452 may comprise one or more buttons, a keyboard, and a mouse or other pointing device. The I/O device interface 414 also includes an audio output unit configured to generate an electrical audio output signal. User I/O devices 452 include a speaker configured to generate an acoustic output in response to the electrical audio output signal. In alternative embodiments, the display device 450 may include the speaker. A television is an example of a device known in the art that can display video frames and generate an acoustic output.

The mass storage unit 416, such as a hard disk drive or flash memory storage drive, is configured to store non-volatile data. The network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, the mass storage unit 416, the I/O device interface 414, and the graphics subsystem 412. The operating system 432 also provides process and memory management models for the user interface 434 and the playback application 436. The user interface 434, such as a window and object metaphor, provides a mechanism for user interaction with endpoint device 108. Persons skilled in the art will recognize the various operating systems and user interfaces that are well-known in the art and suitable for incorporation into the endpoint device 108.

In some embodiments, the playback application 436 is configured to request and receive content from the content server 105 via the network interface 418. Further, the playback application 436 is configured to interpret the content and present the content via a display device 450 and/or user I/O devices 452.

### Reward-Aligned Recommendation Model

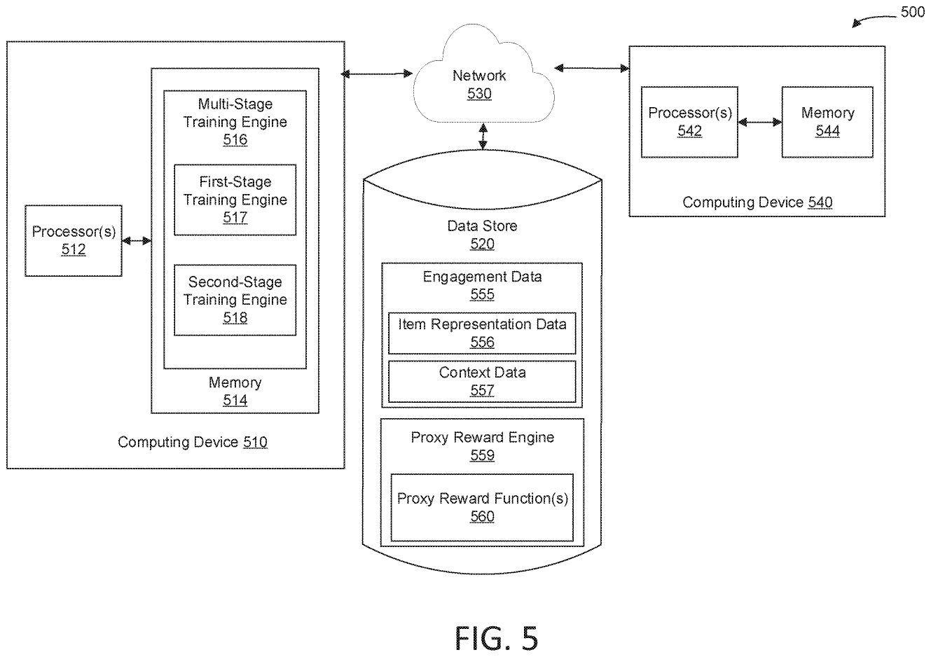

FIG. 5 is a block diagram of a computer-based system 500 according to various embodiments. As shown, the computer-based system 500 includes, without limitation, computing devices 510 and 540, a data store 520, and a network 530. The computing device 510 includes, without limitation, one or more processors 512 and memory 514. The memory 514 includes, without limitation, a multi-stage training engine 516. The multi-stage training engine 516 includes, without limitation, a first stage training engine 517 and a second stage training engine 518. The data store 520 includes, without limitation, engagement data 555 and a proxy reward engine 559 (e.g., reward generation module). Engagement data 555 includes, without limitation, item representation data 556 and context data 557. The proxy reward engine 559 includes, without limitation, one or more proxy reward functions 560. The computing device 540 includes, without limitation, one or more processors 542 and memory 544. Although FIG. 5 is described in the context of recommendation systems, it should be understood that the disclosed techniques are also applicable to other areas of personalization and data-driven systems, such as targeted advertising platforms, product recommendation engines, dynamic user interface customization, personalized educational content delivery, and/or the like.

Computing device 510 shown herein is for illustrative purposes only, and variations and modifications in the design and arrangement of computing device 510 are possible without departing from the scope of the present disclosure. For example, the number of processors 512, the number and/or type of memories 514, and/or the number of applications and/or data stored in memory 514 can be modified as desired. In some embodiments, any combination of processor(s) 512 and/or memories 514 can be included in and/or replaced with any type of virtual computing system, distributed computing system, and/or cloud computing environment, such as a public, private, or a hybrid cloud system.

Each of the processors 512 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 512 can be any technically feasible hardware unit capable of processing data and/or executing software applications.

Memory 514 of computing device 510 stores content, such as software applications and data, for use by processors 512. Memory 514 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 514. The storage can include any number and type of external memories that are accessible to processors 512. For example, and without limitation, the storage can include a Secure Digital Card, an external Flash memory, a portable CD-ROM, an optical storage device, a magnetic storage device, and/or any suitable combination of the foregoing.

As shown, memory 514 includes, without limitation, a multi-stage training engine 516 that includes a first-stage training engine 517 and a second-stage training engine 518. Although shown in the context of a multi-stage training engine 516, it should be understood that first-stage training engine 517 and the second-stage training engine 518 may be logically separate, combined together, or any combination thereof. For example, the actions described here with respect to the first-stage training engine 517 and the second-stage training engine 518 may be performed by a single element. As another example, the first-stage training engine 517 may be completely separate from the second-stage training engine 518, without distinct multi-stage training engine 516. As discussed in more detail below, the first-stage training engine 517 may train a recommendation model using engagement data 555 to generate a pre-trained recommendation model 604. The second-stage training engine 518 may train the pre-trained recommendation model 604 using one or more proxy reward functions 560 to generate a reward-aligned recommendation model.

The data store 520 can include any storage device or devices, such as fixed disc drive(s), flash drive(s), optical storage, network-attached storage (NAS), and/or a storage area network (SAN). Although shown as accessible over network 530, in some embodiments computing device 510 can include data store 520. As shown, data store 520 may store, without limitation, user engagement data 555 and proxy reward data 559. The user engagement data 555 may include, without limitation, item representation data 556 and context data 557. The item representation data 556 may include data representing a particular item that has been recommended (e.g., suggested) and/or could be recommended to a user. Non-exclusive examples of item representation data 556 may include a stock keeping unit (SKU) code, product code, and/or any other digital representation of an item. The context data 557 may include data pertinent to short-term engagement. As an example, the context data 557 may include, without limitation, historical data about a user (or set of users), which may include broad patterns of user behavior and activity across various recommendation tasks to provide insights into what the user engages with, how the user interacts, and the preferences of the user over time. Non-exclusive examples of context data 557 may include user interaction information such as skips, plays, thumbs up/down evaluations, adding items to a playlist, clicks, viewing history, product views, items added to carts, purchase history, likes, shares, comments, profile visits, and the like. In some cases, the context data 557 may include user feedback data, for example, based on previously suggested items. Context data 557 associated with a particular item representation (e.g., as included in a context-item pair) may be the data pertinent to short-term engagement for the particular item. For example, the context data 557 associated with an item may include which user interactions are commonly associated with the particular item. In some cases, the context data 557 and/or item representation data 556 may be included in one or more vectors.

The proxy reward data 559 may include, without limitation, one or more proxy reward functions 560. The proxy reward functions 560 may represent long-term user preferences. For example, the proxy reward functions 560 may map a particular item representation and context data 557 to a reward value. The reward value may indicate how much the particular item may contribute to long-term satisfaction of the user. In some cases, the proxy reward functions 560 may be based on (e.g., a function of) one or more metrics, such as whether a user watches a media item to completion, which may be combined to provide an indication of long-term user satisfaction.

In some cases, the proxy reward data 559 may be stored in conjunction with engagement data 555. As indicated above, the engagement data 555 may include item representation data 556 and context data 557. In some cases, the item representation data 556 and context data 557 may be stored in conjunction with the engagement data 555 as a plurality of triplets. For example, a particular item, as represented by the item representation data 556, may be associated with a particular context data 557 and a reward value determined from a proxy reward function 560. In some cases, a triplet may be represented as (xi, ai, ri), where xi∈X encodes the context data 557, ai∈A represents the item (e.g., item representation data 556) from a set of items A, and ri∈R represents a reward value associated with the item and context data 557 of the triplet. The proxy reward function 560 R may map an item (ai) and context data (xi) pair to the corresponding reward value (ri) for a triplet.

Network 530 can be a wide area network (WAN), such as the Internet, a local area network (LAN), a cellular network, and/or any other suitable network. Computing devices 510 and 540 and data store 520 are in communication over network 530. For example, network 530 can include any technically feasible network hardware suitable for allowing two or more computing devices to communicate with each other and/or to access distributed or remote data storage devices, such as data store 520.

Computing device 540 shown herein is for illustrative purposes only, and variations and modifications in the design and arrangement of computing device 540 are possible without departing from the scope of the present disclosure. For example, the number of processors 542, the number and/or type of memories 544, and/or the number of applications and/or data stored in memory 544 can be modified as desired. In some embodiments, any combination of processor(s) 542 and/or memory 544 can be included in and/or replaced with any type of virtual computing system, distributed computing system, and/or cloud computing environment, such as a public, private, or hybrid cloud system.

Each of processor(s) 542 can be any suitable processor, such as a CPU, a GPU, an ASIC, an FPGA, a DSP, a multicore processor, and/or any other type of processing unit, or a combination of two or more of the same type and/or different types of processing units, such as a SoC, or a CPU configured to operate in conjunction with a GPU. In general, processors 542 can be any technically feasible hardware unit capable of processing data and/or executing software applications. During operation, processor(s) 542 can receive user inputs and item inputs from input devices (not shown), such as a keyboard or a mouse.

Memory 544 of computing device 540 stores content, such as software applications and data, for use by processor(s) 542. Memory 544 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 544. The storage can include any number and type of external memories that are accessible to processor(s) 542. For example, and without limitation, the storage can include a Secure Digital Card, an external Flash memory, a portable CD-ROM, an optical storage device, a magnetic storage device, and/or any suitable combination of the foregoing.

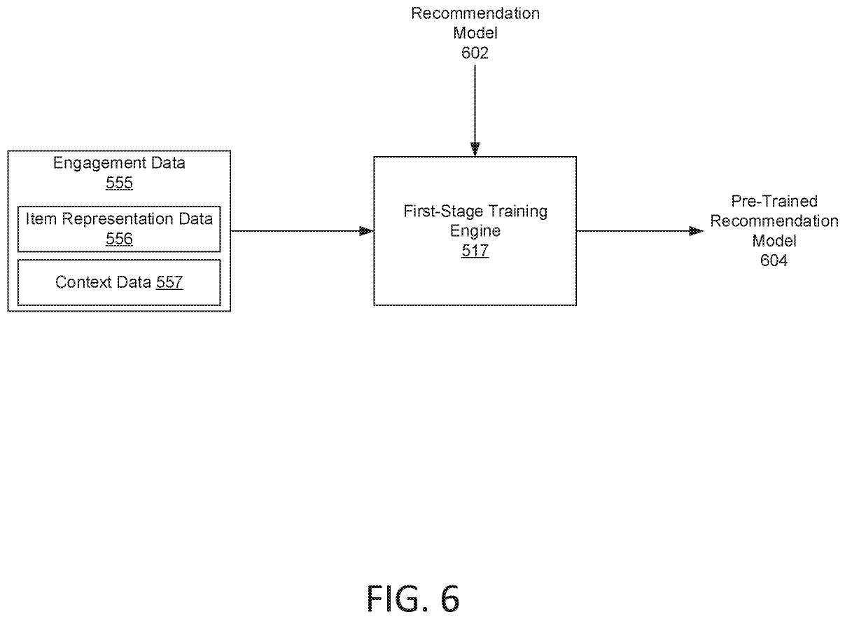

FIG. 6 illustrates a first stage training of multi-staged training for the reward-aligned recommendation model, in accordance with aspects of the present disclosure. As shown in FIG. 6, the first-stage training engine 517 may obtain engagement data 555, including, without restriction, item representation data 556 and context data 557, for use to train an input recommendation model 602. The first-stage training engine 517 may then train the recommendation model 602 using the engagement data 555 to generate a pre-trained recommendation model 604.

In some cases, the recommendation model 602 may be any machine learning (ML) model capable of providing recommended items from a set of items. For example, the recommendation model 602 may be, without limitation, a neural network, a convolutional neural network, a transformer based neural network, any combination thereof, etc. The first-stage training engine 517 may apply any ML training technique to train the recommendation model 602. Non-exclusive examples of training techniques that may be used by the first-stage training engine 517 may include supervised learning, unsupervised learning, reinforcement learning, any combination thereof, etc.

In some cases, the first-stage training engine 517 may teach the recommendation model 602 to learn which items may be recommended to the user as the next potential selection based on contextual data 557. For example, the recommendation model 602 may learn, via reinforcement learning based on events obtained from a plurality of other users, to associate a certain item with certain historical events, such as certain actions performed by the user, items previously selected by the user, etc., and the recommendation model 602 may be more likely to recommend the item when the user is associated with those certain historical events. Reinforcement learning may be a ML technique whereby the ML model learns to make decisions by performing actions in an environment to maximize cumulative rewards.

The first stage of training (e.g., first training stage) may have a different training objective as compared to a second stage of training (e.g., second training stage), as discussed in more detail below. For example, the first training stage may train the recommendation model 602 to predict items with an objective of short-term engagement. As discussed above, training with an objective of short-term engagement may train the recommendation model 602 to better predict one or more items that a user is likely to select (e.g., choose) next. In some cases, the recommendation model 602 may be trained, as a part of the first training stage, to perform sub-objectives, such as retrieval tasks and/or ranking tasks. Retrieval sub-objectives may involve selecting a subset of items from a set of items that may be recommended (e.g., recommended items). Ranking sub-objectives may include ordering the selected subset of items based on a predicted relevance for a user.

To allow the first-stage training by the first-stage training engine 517 to focus on the short-term engagement objective, the first-stage training may be decoupled from training on the long-term user satisfaction objective of the second-stage training. As indicated above, the proxy reward functions and proxy reward data may represent long-term user preferences. Thus, to decouple the first-stage training from the second-stage training, the first-stage training may omit the proxy reward data, proxy reward functions, and/or any particular proxy reward values.

After the first stage of training is performed, the first-stage training engine 517 may output the pre-trained recommendation model 604.

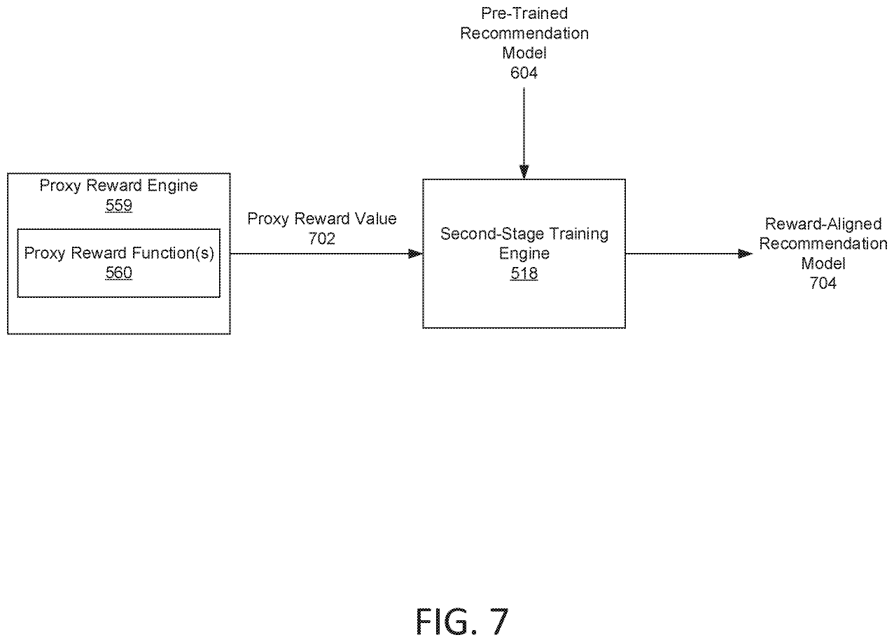

FIG. 7 illustrates a second stage training of multi-staged training for the reward-aligned recommendation model, in accordance with aspects of the present disclosure. As shown in FIG. 7, the second stage training engine 518 may obtain one or more proxy reward values 702 based on one or more proxy reward functions 560 from the proxy reward engine 559 for use to train the pre-trained recommendation model 604 to generate a reward-aligned recommendation model 704. In some cases, the second stage training engine 518 may use reinforcement learning to train the pre-trained recommendation model 604.

As indicated above, an ultimate long-term user satisfaction metric may be whether a user renews a subscription to a service. However, the long-term user satisfaction metric may be subject to many variables, such as an economic situation of a user, how busy the user is, etc., and thus, direct attribution of the long-term user satisfaction metric to any particular recommended item may be difficult. In some cases, contextual bandits may be used to provide proxies for the long-term user satisfaction metric. Contextual bandits may be a class of algorithms which may evaluate various events (e.g., actions) to predict which events are likely to result in a highest reward for a given user. Events may include, for example, various inputs such as, without limitations, real-time interactions such as clicks, searches, likes, plays, other immediate user activities, direct interactions, browsing activity, implicit feedback such as engagement duration and skipped items, and/or the like.

The reward may be used to provide a feedback (e.g., positive or negative) signal that combines in conjunction with other reward values to the long-term satisfaction metric. The proxy reward function 560 R may map a particular item and corresponding context pair context-item pair (x, a) to a reward r. In some cases, the item, context, and reward may be stored as a triplet (xi, ai, ri). In some examples, long-term satisfaction may be defined as li∈R. The second stage training may involve learning, for a given proxy reward function 560 R, a model πR (e.g., reward-aligned recommendation model 704) that maximizes an expected reward JR(π)=Ex[r|π]. In some cases, an expected long-term satisfaction term may be defined as Jl(π)=Ex[l|π]. The expected long-term satisfaction term may be maximized by allowing the model πR to learn from the proxy reward function 560 R and thus the model πR may align with the long-term user satisfaction. For example, as a part of the second-stage training, the model πR may select actions (e.g., recommending particular items) based on the context data to obtain a certain reward, where the reward acts like a signal to indicate how aligned the action is with the long-term user satisfaction. In some cases, the reward may be used to determine a loss value for training the model πR. The aligned model πR may be output as the reward-aligned recommendation model 704.

As indicated above, the proxy reward functions 560 R may map items and associated context information to a reward. Different types and/or formulations of the proxy reward function 560 R may be used. For example, the proxy reward functions 560 R may use linear functions, logistic functions, sums of individual functions, a neural network, any combination thereof, and the like. In some cases, the proxy reward functions 560 may be refined or adjusted over time, for example, to better align with long-term user satisfaction.

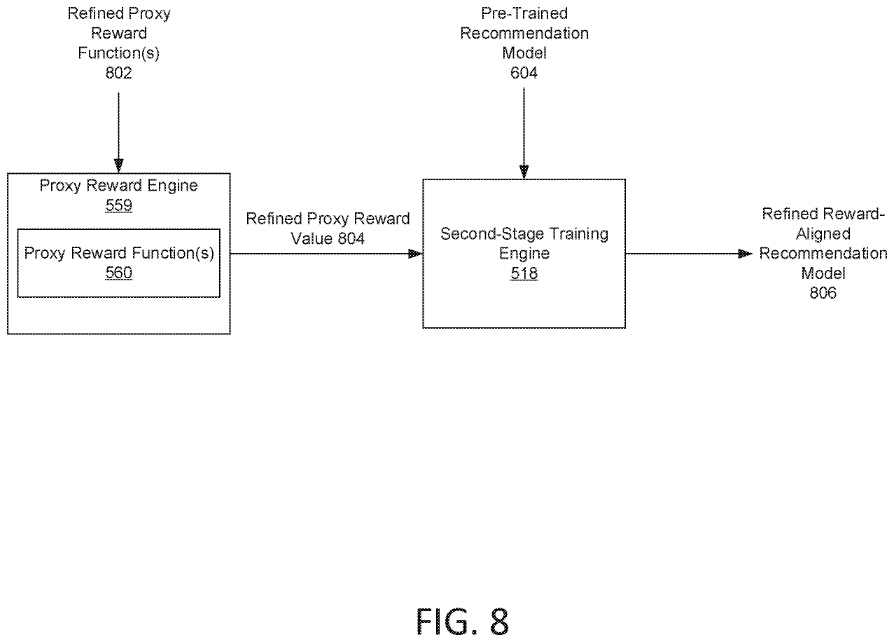

FIG. 8 illustrates training for the reward-aligned recommendation model using refined proxy reward functions, in accordance with aspects of the present disclosure. In some cases, proxy reward functions may be refined over time to develop one or more refined proxy reward functions 802 that better align with long-term user satisfaction as compared to another proxy reward function. For example, monitored events may be changed, a function type may be changed, a function may be adjusted, etc., and one or more refined proxy reward functions 802 may be defined based on such changes. The refined proxy reward functions 802 may be input to the proxy reward engine 559.

In some cases, the refined proxy reward functions 802 may be stored with other proxy reward functions 560, for example in a data store (not shown). In some cases, one or more refined proxy reward functions 802 may be selected and used to generate a refined proxy reward value 804 for use in training by the second-stage training engine 518. In some cases, the one or more refined proxy reward functions 802 may be selected based on how well the one or more refined proxy reward functions 802 align with long-term user preferences.

The second-stage training engine 518 may then train the pre-trained recommendation model 604 using the refined proxy reward value 804 to obtain a refined reward aligned recommendation model 806 in a manner substantially similar to that discussed above with respect to FIG. 7. For example, the refined proxy reward value 804 may be similar to the proxy reward value 702, except that the refined proxy reward value 804 may be determined based on the one or more refined proxy reward functions 802. Similarly, the refined reward aligned recommendation model 806 may be similar to the reward aligned recommendation model 806, except that the refined reward aligned recommendation model 806 is trained based on the refined proxy reward value 804.

By training the pre-trained recommendation model 604 using the refined proxy reward value 804, instead of retraining with a recommendation model 602, allows the pre-trained recommendation model 604 to be used with different sets of proxy reward functions. Advantageously, the pre-trained recommendation model 604 may not have to be retrained (e.g., training as shown in FIG. 7 may be bypassed) when used to train with the refined proxy reward value 804 to obtain the refined reward-aligned recommendation model 806. Thus, the same pre-trained recommendation model 604 may be used as a part of training the reward-aligned recommendation model 704, and the pre-trained recommendation model 604 may be reused as a part of training the refined reward-aligned recommendation model 806. The reuse of the pre-trained recommendation model 604 can save significant computation and/or model training costs. For example, use of the pre-trained recommendation model 604 can reduce training costs and/or use of training resources by up to 70%. Additionally, the reduction in computation and/or model training costs can better allow the exploration of different proxies for long-term user satisfaction, thereby enabling the proxy reward functions 560 and refined proxy reward functions 802 to become more expressive over time.

In some cases, as the first stage training and the second stage training have differing training objectives, the data sets used for training (e.g., bandits and/or events used) may differ between the first stage training and the second stage training. In some cases, certain parameters, bandits, and/or events may be excluded from one stage or the other. For example, training using a certain parameter may be appropriate in the first stage training, but inclusion of the certain parameter in the second stage training may result in “unlearning” of the training from the first stage. In some cases, parameter tuning and/or dataset crafting may be used, for example, as a part of refining the proxy reward function.

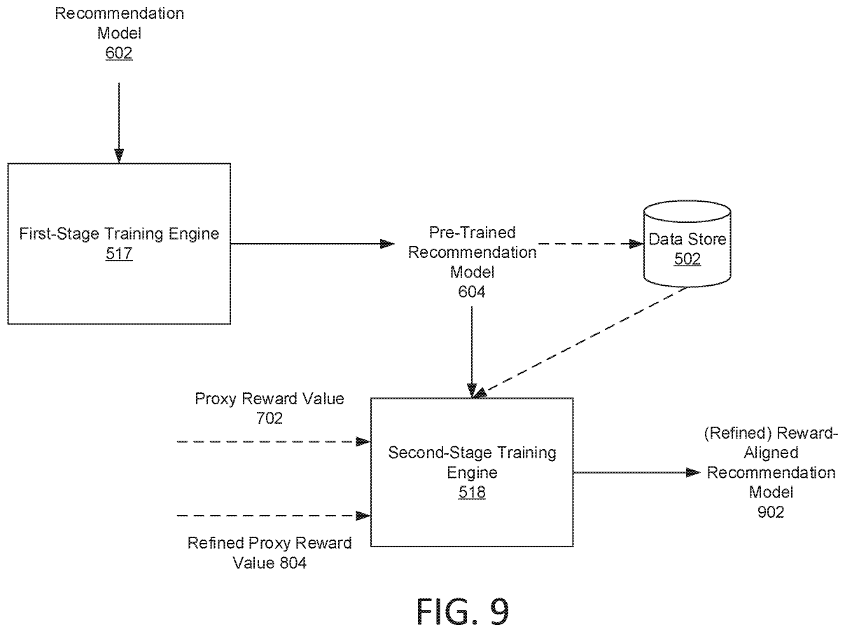

FIG. 9 provides further details for pre-trained recommendation model reuse, in accordance with aspects of the present disclosure. In FIG. 9, the recommendation model 602 may be input to, and trained by, the first-stage training engine 517 to generate the pre-trained recommendation model 604 in a manner substantially similar to that discussed above with respect to FIGS. 6 and 7.

In some cases, the pre-trained recommendation model 604 output from the first-stage training engine 517 may be stored, for example, in data store 502 or any other non-transitory memory, such as memory 514 of FIG. 5. Storing the pre-trained recommendation model 604 allows the pre-trained recommendation model 604 to be reused at a later time. For example, the stored pre-trained recommendation model 604 may be used to train with the proxy reward value 702 to generate the reward aligned recommendation model 704 and to train with the refined proxy reward value 804 to generate the refined reward aligned recommendation model 806. For example, the stored pre-trained recommendation model 604 may be trained with the proxy reward value 702 by the second-stage training engine 518 to generate a reward aligned recommendation model 902, and the same stored pre-trained recommendation model 604 may be trained (e.g., reused) with the refined proxy reward value 804 to generate a refined reward aligned recommendation model 902. Training by the second-stage training engine 518 with the proxy reward value 702 or refined proxy reward value 804 may be substantially similar to that discussed above with respect to FIG. 7 or 8, respectively.

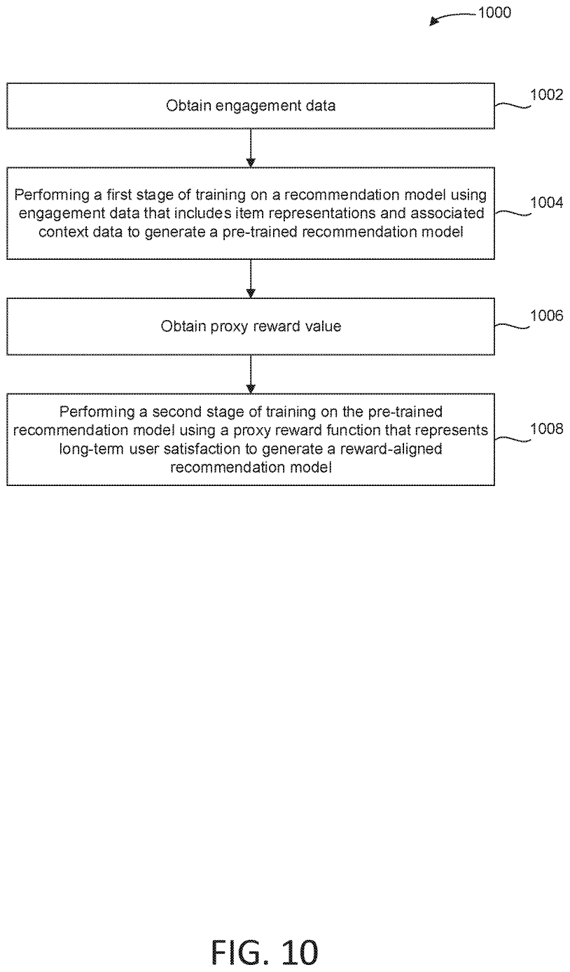

FIG. 10 is a flow diagram illustrating a technique 1000 for implementing reward alignments for recommendation systems, in accordance with aspects of the present disclosure. Although the technique 1000 is described in conjunction with FIGS. 1-8, persons skilled in the art will understand that any system configured to perform steps of the technique 1000, in any order, falls within the scope of the various embodiments. The technique 1000 may be performed by a computing device, such as control server 120, content server 110, endpoint device 115, computing device 510, computing device 540, data store 520, or a component of the computing device.

The technique 1000 begins at step 1002. At step 1002, a computing device may obtain engagement data (e.g., engagement data 555). The engagement data may include context (e.g., context data 557) and item representations (e.g., item representation data 556). In some cases, the context may be based on short-term engagement metrics such as a click-through rate or take rate of recommended items. In some cases, the engagement data may be structured as a plurality of triplets, where each triplet includes the context, the recommended item (e.g., item representation data 556), and a reward value (e.g., proxy reward value 702).

At step 1004, the computing device may perform a first stage of training (e.g., by a first-stage training engine 517) on a recommendation model (e.g., recommendation model 602) using the engagement data to generate a pre-trained recommendation model (e.g., pre-trained recommendation model 604). The first stage of training may use training techniques such as supervised learning, unsupervised learning, reinforcement learning, any combination thereof, etc. In some cases, recommendation model 602 may be trained using the context and recommended item of the engagement data. The first stage of training may omit the use of the proxy reward function and/or proxy reward value 702 for training recommendation model 602.

At step 1006, the computing device may obtain a proxy reward value (e.g., proxy reward value 702). In some cases, proxy reward value 702 may be based on a proxy reward function. Proxy reward value 702 may be associated with a particular context and recommended item (e.g., context-item pair). Proxy reward value 702 may represent long-term user preferences for a particular context-item pair. The proxy reward function may be based on indirect metrics for long-term user preferences, such as whether a user renews the service next month, year, etc., a number of days in some time period (e.g., week, month, year, etc.) the user accesses the service, a number of minutes the user uses the service over a time period, etc. Indirect metrics may be used because direct attribution of long-term user preferences to any particular recommended item can be difficult. The proxy reward function may map a context-item pair to a long-term satisfaction value (e.g., proxy reward value 702). In some cases, proxy reward value 702 may be obtained along with the engagement data.

At step 1008, a computing device (or component thereof) may perform a second stage of training on the pre-trained recommendation model using a proxy reward function that represents long-term user satisfaction (e.g., long-term user preferences) to generate a reward-aligned recommendation model (e.g., reward-aligned recommendation model 704). In some cases, the second stage of training may be performed using reinforcement learning. In some examples, the proxy reward function is selected from a set of candidate reward functions based on alignment with the long-term user preferences represented by the proxy reward function.

In sum, a recommendation system may be trained to generate recommendations that can yield short-term user engagements as well as increase long-term user satisfaction. To provide optimization for multiple learning objectives, the recommendation system may be trained using a multi-stage training methodology. In some cases, stages of the multi-stage training methodology may be organized based on the learning objectives. For example, a first stage of training may be performed based on a short-term user engagement objective using engagement data to generate a pre-trained recommendation model. The pre-trained recommendation model may be reused Such engagement data may include item representations along with context. An item representation may be a representation of an item (e.g., a recommended item), and the context may encode historical preferences for the item. In some cases, the engagement data may be structured as a plurality of triplets, where a triplet of the plurality includes a representation of an item (e.g., a recommended item), context information encoding historical preferences of the user, and a reward. Values of the reward may be related to the long-term satisfaction objective and the first stage of training may bypass (e.g., exclude) the use of any particular reward function and/or the reward value. Rather, the reward function and reward value may be used in a second stage of training based on the long-term user satisfaction objective.

The second stage of training may be performed on the pre-trained recommendation model to generate a reward-aligned recommendation model using a proxy reward function. The proxy reward function may represent long-term user preferences. The proxy reward function may map reward values of a triplet to the corresponding item representation and context. In some cases, the proxy reward function may be based on one or more metrics, such as whether a user watches a media item to completion, where one or more metrics may be combined to provide an indication of long-term user satisfaction. The proxy reward function may be refined over time to better align with long-term user satisfaction. In some cases, the second stage of training may be performed using a refined proxy reward function. The pre-trained recommendation model from the first stage of training may be reused to train the refined proxy reward function without retraining the pre-trained recommendation model.

One technical advantage of the disclosed techniques relative to prior approaches is that the disclosed techniques implement a multi-stage training methodology for a reward-aligned recommendation model that reduces the technical burden associated with incorporating long-term user satisfaction into recommendation processing. More specifically, a first stage of training can generate a pre-trained recommendation model using engagement data associated with short-term user engagement, while a second stage of training can adapt the pre-trained recommendation model using proxy reward values that represent long-term user satisfaction. Because the pre-trained recommendation model can be reused across different proxy reward functions and/or refined proxy reward functions, retraining of the pre-trained recommendation model (e.g., to perform item recommendation) may be avoided when the proxy reward function is changed. Thus, the disclosed techniques can avoid repeated end-to-end retraining of the recommendation model each time a long-term satisfaction measurement, weighting, or formulation is adjusted.

As a result, the disclosed techniques can reduce model training cost, processor utilization, memory usage, storage input/output, network bandwidth consumption, and overall computational overhead relative to approaches that retrain an entire recommendation model after refinement of a long-term reward formulation. In addition, the disclosed techniques can improve scalability by allowing multiple candidate proxy reward functions to be evaluated, compared, and refined using the pre-trained recommendation model, thereby enabling more efficient exploration of different long-term satisfaction formulations. The disclosed techniques can also improve technical performance by preserving information learned from short-term engagement data while separately aligning the model with longer-term reward signals that may be sparse, delayed, indirect, and/or noisy. Accordingly, the disclosed techniques can improve training efficiency, reduce system-resource consumption, and facilitate iterative refinement of long-term reward alignment in recommendation systems.

These technical advantages provide one or more technological advancements over prior art approaches.

Aspects of the subject matter described herein are set out in the following numbered clauses.
1. In some embodiments, a computer-implemented method for training reward-aligned recommendation models comprises: performing a first stage of training on a recommendation model using engagement data that includes item representations and associated context data to generate a pre-trained recommendation model; and performing a second stage of training on the pre-trained recommendation model using proxy reward values that represent long-term user satisfaction to generate a reward-aligned recommendation model.
2. The computer-implemented method of clause 1, wherein the engagement data includes a plurality of triplets, and each triplet included in the plurality of triplets includes an item representation, context data associated with the item representation, and a proxy reward value.
3. The computer-implemented method of any of clauses 1-2, wherein a proxy reward function maps an item representation and associated context data to a proxy reward value.
4. The computer-implemented method of any of clauses 1-3, wherein the first stage of training bypasses use of a proxy reward function.
5. The computer-implemented method of any of clauses 1-4, wherein the second stage of training includes generating a proxy reward value using a proxy reward function based on an item representation and associated context data.
6. The computer-implemented method of any of clauses 1-5, wherein the proxy reward function is based on at least one or more metrics that provide an indication of long-term user satisfaction.
7. The computer-implemented method of any of clauses 1-6, wherein the first stage of training includes an application of at least one of a retrieval sub-objective or a ranking sub-objective.
8. The computer-implemented method of any of clauses 1-7, wherein a proxy reward function is selected from a set of candidate proxy reward functions based on at least an alignment with long-term user preferences represented by the proxy reward function.
9. The computer-implemented method of any of clauses 1-8, wherein the associated context data includes historical data about one or more users.
10. The computer-implemented method of any of clauses 1-9, further comprising: obtaining refined proxy reward values based on at least one or more refined proxy reward functions; and performing the second stage of training on the pre-trained recommendation model to generate a refined reward-aligned recommendation model.
11. In some embodiments, one or more non-transitory computer readable media store instructions that, when executed by one or more processors, cause the one or more processors to train reward-aligned recommendation models, by performing the operations of: performing a first stage of training on a recommendation model using engagement data that includes item representations and associated context data to generate a pre-trained recommendation model; and performing a second stage of training on the pre-trained recommendation model using proxy reward values that represent long-term user satisfaction to generate a reward-aligned recommendation model.
12. The one or more non-transitory computer readable media of clause 11, wherein the second stage of training is based on reinforcement learning.
13. The one or more non-transitory computer readable media of any of clauses 11-12, wherein the instructions further cause the one or more processors to perform the operation of storing the pre-trained recommendation model for generating one or more refined reward-aligned recommendation models.
14. The one or more non-transitory computer readable media of any of clauses 11-13, wherein the instructions further cause the one or more processors to perform the operations of: obtaining refined proxy reward values based on one or more refined proxy reward functions; performing the second stage of training on the pre-trained recommendation model to generate a refined reward-aligned recommendation model.
15. The one or more non-transitory computer readable media of any of clauses 11-14, wherein the engagement data comprises a plurality of triplets, and each triplet included in the plurality of triplets comprises an item representation, context data associated with the item representation, and a proxy reward value.
16. The one or more non-transitory computer readable media of any of clauses 11-15, wherein a proxy reward function maps an item representation and associated context data to a proxy reward value.
17. The one or more non-transitory computer readable media of any of clauses 11-16, wherein the second stage of training includes generating a proxy reward value using a proxy reward function based on an item representation and associated context data.
18. The one or more non-transitory computer readable media of any of clauses 11-17, wherein a proxy reward function is selected from a set of candidate proxy reward functions based on at least an alignment with long-term user preferences represented by the proxy reward function.
19. The one or more non-transitory computer readable media of any of clauses 11-18, wherein the associated context data includes historical data about one or more users.
20. In some embodiments, a computer system comprises one or more memories that include instructions, and one or more processors that are coupled to the one or more memories and that execute the instructions to train reward-aligned recommendation models, by performing the operations of: performing a first stage of training on a recommendation model using engagement data that includes item representations and associated context data to generate a pre-trained recommendation model, and performing a second stage of training on the pre-trained recommendation model using proxy reward values that represent long-term user satisfaction to generate a reward-aligned recommendation model.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of application data, content servers, and client devices, persons skilled in the art will appreciate that the systems and techniques described herein are applicable to other types of application data, content servers, and client devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training reward-aligned recommendation models, the method comprising:
performing a first stage of training on a recommendation model using engagement data that includes item representations and associated context data to generate a pre-trained recommendation model; and
performing a second stage of training on the pre-trained recommendation model using proxy reward values that represent long-term user satisfaction to generate a reward-aligned recommendation model.

2. The computer-implemented method of claim 1, wherein the engagement data includes a plurality of triplets, and each triplet included in the plurality of triplets includes an item representation, context data associated with the item representation, and a proxy reward value.

3. The computer-implemented method of claim 1, wherein a proxy reward function maps an item representation and associated context data to a proxy reward value.

4. The computer-implemented method of claim 1, wherein the first stage of training bypasses use of a proxy reward function.

5. The computer-implemented method of claim 1, wherein the second stage of training includes generating a proxy reward value using a proxy reward function based on an item representation and associated context data.

6. The computer-implemented method of claim 5, wherein the proxy reward function is based on at least one or more metrics that provide an indication of long-term user satisfaction.

7. The computer-implemented method of claim 1, wherein the first stage of training includes an application of at least one of a retrieval sub-objective or a ranking sub-objective.

8. The computer-implemented method of claim 1, wherein a proxy reward function is selected from a set of candidate proxy reward functions based on at least an alignment with long-term user preferences represented by the proxy reward function.

9. The computer-implemented method of claim 1, wherein the associated context data includes historical data about one or more users.

10. The computer-implemented method of claim 1, further comprising:
obtaining refined proxy reward values based on at least one or more refined proxy reward functions; and
performing the second stage of training on the pre-trained recommendation model to generate a refined reward-aligned recommendation model.

11. One or more non-transitory computer readable media storing instructions that, when executed by one or more processors, cause the one or more processors to train reward-aligned recommendation models, by performing the operations of:
performing a first stage of training on a recommendation model using engagement data that includes item representations and associated context data to generate a pre-trained recommendation model; and
performing a second stage of training on the pre-trained recommendation model using proxy reward values that represent long-term user satisfaction to generate a reward-aligned recommendation model.

12. The one or more non-transitory computer readable media of claim 11, wherein the second stage of training is based on reinforcement learning.

13. The one or more non-transitory computer readable media of claim 11, wherein the instructions further cause the one or more processors to perform the operation of storing the pre-trained recommendation model for generating one or more refined reward-aligned recommendation models.

14. The one or more non-transitory computer readable media of claim 13, wherein the instructions further cause the one or more processors to perform the operations of:
obtaining refined proxy reward values based on one or more refined proxy reward functions;
performing the second stage of training on the pre-trained recommendation model to generate a refined reward-aligned recommendation model.

15. The one or more non-transitory computer readable media of claim 11, wherein the engagement data comprises a plurality of triplets, and each triplet included in the plurality of triplets comprises an item representation, context data associated with the item representation, and a proxy reward value.

16. The one or more non-transitory computer readable media of claim 11, wherein a proxy reward function maps an item representation and associated context data to a proxy reward value.

17. The one or more non-transitory computer readable media of claim 11, wherein the second stage of training includes generating a proxy reward value using a proxy reward function based on an item representation and associated context data.

18. The one or more non-transitory computer readable media of claim 11, wherein a proxy reward function is selected from a set of candidate proxy reward functions based on at least an alignment with long-term user preferences represented by the proxy reward function.

19. The one or more non-transitory computer readable media of claim 11, wherein the associated context data includes historical data about one or more users.

20. A computer system, comprising:
one or more memories that include instructions; and
one or more processors that are coupled to the one or more memories and that, execute the instructions to train reward-aligned recommendation models, by performing the operations of:
performing a first stage of training on a recommendation model using engagement data that includes item representations and associated context data to generate a pre-trained recommendation model; and
performing a second stage of training on the pre-trained recommendation model using proxy reward values that represent long-term user satisfaction to generate a reward-aligned recommendation model.
